(19) United States
(12) Patent Application Publication
(10) Pub. No.: US 2024/0021805 A1
(43) Pub. Date: Jan. 18, 2024

(54) NEGATIVE ELECTRODE ACTIVE MATERIAL, NEGATIVE ELECTRODE ACTIVE MATERIAL LAYER AND LITHIUM-ION BATTERY, AND METHOD FOR PRODUCING NEGATIVE ELECTRODE ACTIVE MATERIAL

(71) Applicant: TOYOTA JIDOSHA KABUSHIKI KAISHA, Toyota-shi (JP)

(72) Inventors: Mitsutoshi OTAKI, Susono-shi (JP); Jun YOSHIDA, Mishima-shi (JP); Shinji NAKANISHI, Mishima-shi (JP); Hisatsugu YAMASAKI, Gotemba-shi (JP); Natsuki KIKUCHI, Gotemba-shi (JP); Yasuhiro YAMAGUCHI, Kariya-shi (JP); Tatsuya EGUCHI, Kariya-shi (JP); Masanori HARATA, Kariya-shi (JP); Kota URABE, Kariya-shi (JP)

(73) Assignee: TOYOTA JIDOSHA KABUSHIKI KAISHA, Toyota-shi (JP)

(21) Appl. No.: 18/351,162

(22) Filed: Jul. 12, 2023

(30) Foreign Application Priority Data
Jul. 15, 2022 (JP) 2022-114226

(51) Int. Cl. H01M 4/38; H01M 10/0525; H01M 4/04

(52) U.S. Cl. CPC H01M 4/386; H01M 10/0525; H01M 4/0409; H01M 2004/027

(57) ABSTRACT

The present disclosure provides primarily a negative electrode active material with reduced volume change during charge-discharge. The negative electrode active material of the disclosure consists of clathrate-type Si particles comprising one or more metals selected from the group consisting of Mo, Fe, Zn, Mg, Pd, Zr, Ag, Co, Cr, Nb and V. A negative electrode active material layer according to the disclosure comprises the negative electrode active material of the disclosure, and a lithium-ion battery of the disclosure comprises the negative electrode active material layer of the disclosure.

### FIELD

The present disclosure relates to a negative electrode active material, a negative electrode active material layer and a lithium-ion battery, and to a method for producing a negative electrode active material.

### BACKGROUND

In recent years, there has been an ongoing surge in the development of batteries. In the automotive industry, for example, development of batteries for electric vehicles and hybrid vehicles continues to advance. Si is one active material known for use in batteries.

PTL 1 discloses an active material having a silicon clathrate type II crystal phase, with the composition: NaₓSi₁₃₆ (1.98<x<2.54).

### CITATION LIST

### Patent Literature

### [PTL 1] Japanese Unexamined Patent Publication No. 2021-158003

### SUMMARY

### Technical Problem

Si particles used as an active material are effective for achieving high energy density for batteries, but they also result in significant volume change during charge-discharge.

The Si particles with the clathrate structure described in PTL 1 are advantageous for reducing volume change during charge-discharge.

However, there is still a need for further reducing the volume change of Si particles during charge-discharge.

The main object of this disclosure is to provide a negative electrode active material with reduced volume change during charge-discharge.

### Solution to Problem

The present inventors have found that the aforementioned object can be achieved by the following means:

### <Aspect 1>

A negative electrode active material consisting of clathrate-type Si particles comprising one or more metals selected from the group consisting of Mo, Fe, Zn, Mg, Pd, Zr, Ag, Co, Cr, Nb and V.

### <Aspect 2>

The negative electrode active material according to aspect 1, wherein the content of the metal with respect to the entire clathrate-type Si particles is 0.01 to 1.60 mass %.

### <Aspect 3>

The negative electrode active material according to aspect 1 or 2, wherein the metal is interstitially doped in the clathrate-type Si particles.

### <Aspect 4>

The negative electrode active material according to any one of aspects 1 to 3, wherein the clathrate-type Si particles at least partially have a clathrate type II structure.

### <Aspect 5>

The negative electrode active material according to any one of aspects 1 to 4, which is for a lithium-ion battery.

### <Aspect 6>

A negative electrode active material layer comprising a negative electrode active material according to any one of aspects 1 to 5.

### <Aspect 7>

A lithium-ion battery having a negative electrode collector layer, a negative electrode active material layer according to aspect 6, a solid electrolyte layer, a positive electrode active material layer and a positive electrode collector layer, in that order.

### <Aspect 8>

A method for producing a negative electrode active material, wherein the method includes:
supplying a mixture of NaSi alloy powder, a Na trap agent, and one or more metals selected from the group consisting of Mo, Fe, Zn, Mg, Pd, Zr, Ag, Co, Cr, Nb and V, and
heating the mixture at a heating temperature of 250 to 500° C. for a heating time of 30 to 200 hours.

### <Aspect 9>

The production method according to aspect 8, which further includes mechanically milling a Si source, a NaH source and the metal and heating them to obtain a mixture of the NaSi alloy powder and the metal.

### Advantageous Effects of Invention

According to the present disclosure it is possible to provide primarily a negative electrode active material with reduced volume change during charge-discharge.

### BRIEF DESCRIPTION OF DRAWINGS

FIG. 1 is a schematic view showing a lithium-ion battery according to one embodiment of the disclosure.

### DESCRIPTION OF EMBODIMENTS

Embodiments of the disclosure will now be described in detail. However, the disclosure is not limited to the embodiments described below, and various modifications may be implemented which do not depart from the gist thereof.

### <Negative Electrode Active Material>

The negative electrode active material of the disclosure consists of clathrate-type Si particles comprising one or more metals selected from the group consisting of Mo, Fe, Zn, Mg, Pd, Zr, Ag, Co, Cr, Nb and V.

The negative electrode active material of the disclosure is preferably for a lithium-ion battery, which will be the assumption throughout the following explanation, but there is no problem with application to other types of batteries in which the carrier ion is different from lithium-ion.

While it is not our intention to be limited to any particular principle, it is believed that the principle by which the negative electrode active material particles of the disclosure have reduced volume change during charge-discharge of the battery is as follows.

A Si-based negative electrode active material, such as a Si-based negative electrode active material used in a lithium-ion battery, is known to exhibit a high degree of expansion and contraction during charge-discharge. Clathrate-type Si particles are an active material that reduces the expansion and contraction of such a Si-based negative electrode active material during charge-discharge.

The negative electrode active material of the disclosure, by comprising one or more metals selected from the group consisting of Mo, Fe, Zn, Mg, Pd, Zr, Ag, Co, Cr, Nb and V inside clathrate-type Si particles, has increased conductivity inside the clathrate-type Si particles. Therefore, during charge-discharge of a battery, the negative electrode active material of the disclosure has reduced reaction with lithium inside the particles, i.e. reduced imbalance between absorption and release of lithium. The negative electrode active material of the disclosure thus has reduced volume change during charge-discharge of the battery.

The content of the one or more metals selected from the group consisting of Mo, Fe, Zn, Mg, Pd, Zr, Ag, Co, Cr, Nb and V with respect to the entire clathrate-type Si particles is preferably 0.01 to 1.60 mass %.

If the metal content is 0.01 mass % or greater it will be possible to increase the conductivity inside the clathrate-type Si particles. If the metal content is 1.60 mass % or lower, it will be easier to maintain the crystal structure, notably the clathrate structure, of the clathrate-type Si particles, thus minimizing the effect on the amount of lithium that can be occluded by the clathrate-type Si particles when the metal is introduced into the clathrate-type Si particles.

The metal content in the clathrate-type Si particles may be 0.01 mass % or higher, 0.10 mass % or higher, 0.15 mass % or higher or 0.17 mass % or higher, and 1.60 mass % or lower, 1.00 mass % or lower, 0.50 mass % or lower, or 0.20 mass % or lower.

Preferably, the metal is interstitially doped in the clathrate-type Si particles, or in other words, the metal is doped in a manner such that it does not replace the crystal lattice of the clathrate-type Si particles but rather is infiltrating within the crystal lattice. When the metal is doped in this manner, it is easier to maintain the crystal structure of the clathrate-type Si particles.

Preferably, the clathrate-type Si particles at least partially have a clathrate type II structure. Since a clathrate type II structure is able to occlude large amounts of lithium in its interior basket structure, it undergoes a lower degree of expansion and contraction during charge-discharge.

The clathrate-type Si particles may also have both a portion with a clathrate type I structure and a portion with a clathrate type II structure, for example.

The clathrate-type Si particles may be in particulate form, for example. The mean particle diameter (D50) of the clathrate-type Si particles is not particularly restricted but may be 10 nm or larger or 100 nm or larger, for example. The mean particle diameter (D50) of the clathrate-type Si particles may also be 50 μm or smaller, or 20 μm or smaller, for example. The mean particle diameter (D50) can be calculated using a laser diffraction particle size distribution meter and scanning electron microscope (SEM), for example.

### <Negative Electrode Active Material Layer>

The negative electrode active material layer of the disclosure comprises a negative electrode active material of the disclosure. The negative electrode active material layer of the disclosure may optionally further comprise a solid electrolyte, a conductive aid and a binder.

### <Solid Electrolyte>

The material of the solid electrolyte is not particularly restricted, and it may be any material that can be used as a solid electrolyte for a lithium-ion battery. For example, the solid electrolyte may be a sulfide solid electrolyte, an oxide solid electrolyte or a polymer electrolyte, although this is not limitative.

Examples of sulfide solid electrolytes include, but are not limited to, sulfide-based amorphous solid electrolytes, sulfide-based crystalline solid electrolytes and argyrodite solid electrolytes.

Specific examples of sulfide solid electrolytes include, but are not limited to, Li₂S—P₂S₅ (Li₇P₃S₁₁, Li₃PS₄, Li₈P₂S₉), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂), LiI—Li₂S—P₂O₅, LiI—Li₃PO₄—P₂S₅ and Li₇₋ₓPS₆₋ₓClₓ, as well as combinations thereof.

Examples of oxide solid electrolytes include, but are not limited to, Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄ and Li₃₊ₓPO₄₋ₓNₓ(LiPON).

The sulfide solid electrolyte and oxide solid electrolyte may be glass or crystallized glass (glass ceramic).

Polymer electrolytes include, but are not limited to, polyethylene oxide (PEO) and polypropylene oxide (PPO), and their copolymers.

### <Conductive Aid>

The conductive aid is not particularly restricted. For example, the conductive aid may be, but is not limited to, a carbon material such as VGCF (Vapor Grown Carbon Fibers), Ketjen black (KB), acetylene black (AB) or carbon nanofibers, or a metal material.

### <Binder>

The binder is also not particularly restricted. Examples for the binder include, but are not limited to, materials such as polyvinylidene fluoride (PVdF), butadiene rubber (BR), polytetrafluoroethylene (PTFE) and styrene-butadiene rubber (SBR), or combinations thereof.

### <Lithium-Ion Battery>

The lithium-ion battery of the disclosure has a negative electrode collector layer, a negative electrode active material layer of the disclosure, a solid electrolyte layer, a positive electrode active material layer and a positive electrode collector layer, in that order. The lithium-ion battery of the disclosure may be a secondary battery.

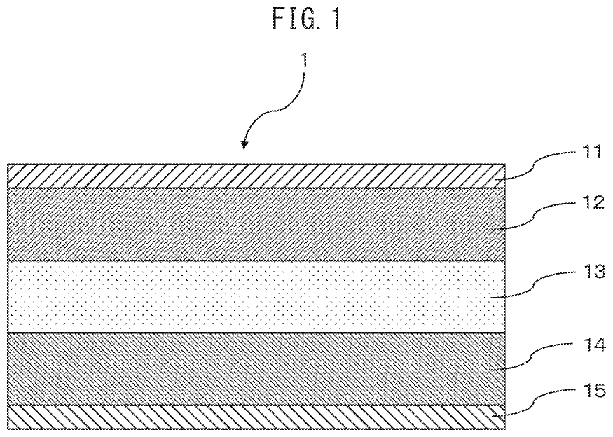

FIG. 1 shows a lithium-ion battery 1 according to one embodiment of the disclosure.

The lithium-ion battery of the disclosure 1 has a negative electrode collector layer 11, a negative electrode active material layer of the disclosure 12, a solid electrolyte layer 13, a positive electrode active material layer 14 and a positive electrode collector layer 15, in that order.

### <Negative Electrode Collector Layer>

The material used for the negative electrode collector layer is not particularly restricted, and any one which can be used as a negative electrode current collector for a battery may be employed as appropriate, examples including, but not being limited to, stainless steel (SUS), aluminum, copper, nickel, iron, titanium, carbon and resin current collectors.

The form of the negative electrode collector layer is not particularly restricted and may be, for example, a foil, sheet, mesh or the like. A foil is preferred among these.

### <Solid Electrolyte Layer>

The solid electrolyte layer is a layer comprising a solid electrolyte and optionally a binder.

For the solid electrolyte and binder, refer to the description under the headers <Negative electrode active material layer>, <Solid electrolyte> and <Binder>.

### <Positive Electrode Active Material Layer>

The positive electrode active material layer is a layer comprising a positive electrode active material, and optionally a solid electrolyte, a conductive aid and a binder.

When the positive electrode active material layer comprises a solid electrolyte, the mass ratio of the positive electrode active material and solid electrolyte in the positive electrode active material layer (positive electrode active material mass:solid electrolyte mass) is preferably 85:15 to 30:70 and more preferably 80:20 to 40:60.

The material of the positive electrode active material is not particularly restricted. Examples for the positive electrode active material include, but are not limited to, heterogenous element-substituted Li—Mn spinel having a composition represented by lithium cobaltate (LiCoO₂), lithium nickelate (LiNiO₂), lithium manganate (LiMn₂O₄), LiCo_{1/3}Ni_{1/3}Mn_{1/3}O₂ and Li₁₊ₓMn_{2-x-y}M_{y}O₄ (where M is one or more metal elements selected from among Al, Mg, Co, Fe, Ni and Zn).

The positive electrode active material may also have a covering layer. The covering layer is a layer comprising a substance that exhibits lithium-ion conductivity, has low reactivity with the positive electrode active material or solid electrolyte, and that can maintain the shape of the covering layer without flowing even when contacting the active material or solid electrolyte. Specific examples of materials to form the covering layer include, but are not limited to, LiNbO₃, Li₄Ti₅O₁₂ and Li₃PO₄.

The positive electrode active material may be in a particulate form, for example. The mean particle diameter (D50) of the positive electrode active material is not particularly restricted but may be 10 nm or larger or 100 nm or larger, for example. The mean particle diameter (D50) of the positive electrode active material may be 50 μm or smaller or 20 μm or smaller, for example. The mean particle diameter (D50) can be calculated using a laser diffraction particle size distribution meter and scanning electron microscope (SEM), for example.

For the solid electrolyte, conductive aid and binder, refer to the description under the headers <Negative electrode active material layer>, <Solid electrolyte>, <Conductive aid> and <Binder> above.

### <Positive Electrode Collector Layer>

The materials and form for the positive electrode collector layer are not particularly restricted, and the same materials and form may be used as described above under the heading <Negative electrode collector layer>. The material of the positive electrode collector layer is preferably aluminum. The layer form is preferably a foil.

### <Method for Producing Negative Electrode Active Material>

The production method of the disclosure is a method for producing a negative electrode active material that includes:
supplying a mixture of NaSi alloy powder, a Na trap agent, and one or more metals selected from the group consisting of Mo, Fe, Zn, Mg, Pd, Zr, Ag, Co, Cr, Nb and V, and
heating the mixture at a heating temperature of 250 to 500° C. for a heating time of 30 to 200 hours.

By mixing the NaSi alloy powder and Na trap agent and heating them at a predetermined temperature and for a predetermined time, Na dissociates from the NaSi alloy, generating a clathrate structure, and specifically clathrate-type Si particles with a clathrate type II structure.

The production method of the disclosure can increase the conductivity inside the produced clathrate-type Si particles, by addition of one or more metals selected from the group consisting of Mo, Fe, Zn, Mg, Pd, Zr, Ag, Co, Cr, Nb and V to the starting material during the process of producing the clathrate-type Si particles.

The Na trap agent is not limited to one that reacts with NaSi alloy and accepts Na from NaSi alloy, since it may be one that reacts with Na that has dissociated from NaSi alloy, and specifically vaporized Na.

Specific examples for the Na trap agent include particles of CaCl₂, CaBr₂, CaI₂, Fe₃O₄, FeO, MgCl₂, ZnO, ZnCl₂, MnCl₂ and AlF₃. AlF₃ particles are most preferred for the Na trap agent.

The heating temperature may be 250° C. or higher, 300° C. or higher or 350° C. or higher, and 500° C. or lower, 450° C. or lower, 400° C. or lower or 350° C. or lower.

The heating time may be 30 hours or longer, 40 hours or longer, 50 hours or longer or 100 hours or longer, and 200 hours or less, 180 hours or less, 160 hours or less or 100 hours or less.

In the production method of the disclosure, one or more metals selected from the group consisting of Mo, Fe, Zn, Mg, Pd, Zr, Ag, Co, Cr, Nb and V may also be added beforehand during production of the NaSi alloy powder.

More specifically, an Si source, a NaH source and the metal may be mechanically milled and heated to obtain a mixture of the NaSi alloy powder and the metal.

The one or more metals selected from the group consisting of Mo, Fe, Zn, Mg, Pd, Zr, Ag, Co, Cr, Nb and V may be prepared as separate metallic particles before mixture with the starting material, or they may be supplied to the cutter of a cutter mill used for the mechanical milling carried out during the process of producing the clathrate-type Si particles. When the metal is supplied to the cutter of the cutter mill, the cutter mill is preferably used while mixing the Na source and Si source, for example, during production of the NaSi alloy powder. When a cutter mill is used during production of the NaSi alloy powder, fresh surfaces will be exposed on the cut NaSi alloy powder, tending to increase the area-to-weight ratio of the NaSi alloy powder. More metal from the cutter mill will thus enter into the NaSi alloy powder more easily when a cutter mill is used during production of the clathrate-type Si particles after the step of producing the NaSi alloy powder.

### EXAMPLES

### Examples 1 to 4 and Comparative Example 1

### Preparation of Active Material

### Comparative Example 1

Using Si particles as the Si source and Na particles as the Na source, the Si particles and Na particles were mixed in a molar ratio of 1:1 and then loaded into a crucible, sealed under an Ar atmosphere and heated at 700° C. to obtain a NaSi alloy. The obtained NaSi alloy was heated at 340° C. in a vacuum (approximately 1 Pa) to remove the Na, obtaining an intermediate having a silicon clathrate type II crystal phase.

The obtained intermediate and Li metal weighed out to a molar ratio of Li/Si=1.7 were mixed with a mortar in an Ar atmosphere to obtain an alloy compound. The obtained alloy compound was reacted with ethanol in an Ar atmosphere to form voids inside the primary particles, thereby obtaining an active material.

### Example 1

Si powder (Si powder without voids inside the primary particles) was prepared as a Si source. The Si source and Li metal weighed out to a molar ratio of Li/Si=4.75 were mixed with a mortar in an Ar atmosphere to obtain an alloy compound. The obtained alloy compound was reacted with ethanol in an Ar atmosphere to obtain Si having voids formed inside the primary particles. The Si source was used with NaH as a Na source to produce NaSi alloy.

The NaH used had been previously washed with hexane. The Na source and Si source, weighed out to a molar ratio of 1.05:1, were mixed using a stainless steel (SUS304) cutter mill. The mixture was heated for 40 hours in a heating furnace with an Ar atmosphere at 400° C. to obtain a powdered NaSi alloy.

The obtained NaSi alloy was used, with AlF₃ as a Na trap agent, in a step of forming a silicon clathrate by a solid phase method.

Specifically, the NaSi alloy and AlF₃, weighed out to a molar ratio of 1:0.20, were mixed using a stainless steel (SUS304) cutter mill to obtain a starting material for reaction. The obtained powdered starting material was placed in a reactor and heated and reacted in a heating furnace with an Ar atmosphere, at a heating temperature of 270° C. for a heating time of 120 hours.

The obtained reaction product was thought to include the target active material and NaF and Al as by-products.

The reaction product was washed using a mixed solvent of HNO₃ and H₂O in a volume ratio of 10:90. The by-products were thus removed from the reaction product. After washing, the product was filtered, and the filtered solid content was dried for 3 hours or longer at 120° C. to obtain a powdered active material.

### Example 2

An active material for Example 2 was obtained by the same method as Example 1, except that the heating conditions in the step of forming the silicon clathrate by the solid phase method were: Ar atmosphere, heating temperature: 290° C., heating time: 100 hours.

### Example 3

A reaction product containing an active material was obtained by the same method as Example 1, except that the heating conditions in the step of forming the silicon clathrate by the solid phase method were: Ar atmosphere, heating temperature: 310° C., heating time: 60 hours.

The obtained reaction product was mixed with ZnCl₂, and the mixture was further heated at 310° C. under an Ar atmosphere, for a heating time of 60 hours. The ratio of Si and ZnCl₂ was 4:3 as mass ratio.

The reaction product was then washed using a mixed solvent of HNO₃ and H₂O in a volume ratio of 90:10. The by-products were thus removed from the reaction product. After washing, the product was filtered, and the filtered solid content was dried for 3 hours or longer at 120° C. to obtain an active material for Example 3.

### Example 4

An active material for Example 4 was obtained in the same manner as Example 3, except that the heating conditions in the step of forming the silicon clathrate by the solid phase method were: Ar atmosphere, heating temperature: 290° C. and heating time: 160 hours, and the mixing ratio of Si and ZnCl₂ was 4:4.

### <Energy Dispersive X-Ray Spectroscopy>

The crystallites of the active material of each Example were measured by energy dispersive X-ray spectroscopy (TEM-EDX). All of the active materials had a clathrate type II crystal structure.

The metal content (mass %) of each active material was also measured. The measurement results are shown in Table 1.

### <Fabrication of Lithium-Ion Battery>

The active material of each Example was used to fabricate a lithium-ion battery for each Example, in the following manner.

### (Formation of Negative Electrode Body)

After adding butyl butyrate, a 5 wt % butyl butyrate solution of a polyvinylidene fluoride (PVDF)-based binder, vapor-grown carbon fiber (VGCF) as a conductive aid, the synthesized active material and a Li₂S—P₂S₅-based glass ceramic as a sulfide solid electrolyte into a polypropylene container, the components were stirred for 30 seconds with an ultrasonic disperser (UH-50 by SMT Corp.). The container was then shaken for 30 minutes with a shaker (TTM-1 by Sibata Scientific Technology, Ltd.) to obtain a negative electrode mixture slurry.

The negative electrode mixture was coated onto a Cu foil by a blade method using an applicator, and dried for 30 minutes on a hot plate heated to 100° C. to obtain a negative electrode body.

### (Formation of Solid Electrolyte Layer)

After adding heptane, a 5 wt % heptane solution of a butylene rubber (BR)-based binder, and a Li₂SP₂S₅-based glass ceramic as a sulfide solid electrolyte into a polypropylene container, the components were stirred for 30 seconds with an ultrasonic disperser (UH-50 by SMT Corp.). The container was then shaken for 30 minutes with a shaker (TTM-1 by Sibata Scientific Technology, Ltd.) to obtain a solid electrolyte slurry.

The solid electrolyte slurry was coated onto an Al foil as a release sheet by a blade method using an applicator, and dried for 30 minutes on a hot plate heated to 100° C., to form a solid electrolyte layer.

Three solid electrolyte layers were fabricated in this manner.

### (Formation of Positive Electrode Body)

After adding butyl butyrate, a 5 wt % butyl butyrate solution of a PVDF-based binder, LiNi_{1/3}Co_{1/3}Mn_{1/3}O₂ with a mean particle diameter of 6 μm as a positive electrode active material, a Li₂S—P₂S₅-based glass ceramic as a sulfide solid electrolyte and VGCF as a conductive aid into a polypropylene container, the components were stirred for 30 seconds with an ultrasonic disperser (UH-50 by SMT Corp.).

The container was then shaken for 3 minutes with a shaker (TTM-1 by Sibata Scientific Technology, Ltd.), stirred for 30 seconds with an ultrasonic disperser and further shaken for 3 minutes with a shaker, to obtain a positive electrode mixture slurry.

The positive electrode mixture slurry was coated onto an Al foil by a blade method using an applicator, and dried for 30 minutes on a hot plate that had been heated to 100° C., to form a positive electrode body.

### (Battery Assembly)

The positive electrode body and the first solid electrolyte layer were laminated in that order. The laminated layers were set in a roll press and pressed at a pressing pressure of 100 kN/cm and a pressing temperature of 165° C. to obtain a positive electrode laminate.

The negative electrode body and the second solid electrolyte layer were laminated in that order. The laminated layers were set in a roll press and pressed at a pressing pressure of 60 kN/cm and a pressing temperature of 25° C. to obtain a negative electrode laminate.

The Al foil release sheets were released from the solid electrolyte layer surfaces of the positive electrode laminate and negative electrode laminate. The Al foil release sheet was then released from a third solid electrolyte layer.

The positive electrode laminate and negative electrode laminate were laminated together with their third solid electrolyte layers on the solid electrolyte layer sides facing each other, and the resulting laminate was set in a flat uniaxial press machine for preliminary pressing at 100 MPa, 25° C. for 10 seconds, after which the resulting laminate was set in a flat uniaxial press machine and pressed for 1 minute at a pressing pressure of 200 MPa and a pressing temperature of 120° C. An all-solid-state battery was thus obtained.

### <Charge-Discharge of Lithium-Ion Battery>

The all-solid-state battery of each Example was constrained with a predetermined constraining pressure using a restraint jig, and the degree of fluctuation in the constraining pressure was measured during constant-current/constant-voltage charging to 4.55 V at a 10 hour rate (1/10 C). The degree of fluctuation in the constraining pressure is the difference between the maximum value and minimum value of the constraining pressure.

The volume expansion rate was calculated based on the degree of fluctuation in the constraining pressure for the all-solid-state battery of each Example. Specifically, the expansion rates of the active materials of Examples 1 to 4 were calculated as relative values with the expansion rate of the active material in Comparative Example 1 as 100.00, and assuming the degree of fluctuation in the constraining pressure to be proportional to the amount of expansion of the active material.

Table 1 shows the expansion rate for each Example.

### <Results>

Table 1 shows the metal amount (mass %) and particle expansion rate for the active material of each Example.

TABLE 1

| | Metal content of active | | | | | Active substance |
|---|---|---|---|---|---|---|
| | substance (mass %) | | | | | expansion rate |
| | Mo | Fe | Zn | Mo + Fe | Total | (relative value) |
| Comp. Ex. 1 | 0.00 | 0.01 | 0.00 | 0.01 | 0.01 | 100.00 |
| Example 1 | 0.02 | 0.00 | 0.00 | 0.02 | 0.19 | 27.50 |
| Example 2 | 0.03 | 0.04 | 0.00 | 0.07 | 0.15 | 25.00 |
| Example 3 | 0.02 | 0.05 | 0.06 | 0.07 | 0.17 | 18.75 |
| Example 4 | 0.01 | 0.10 | 1.47 | 0.11 | 1.58 | 30.00 |

The active materials of Examples 1 to 4, which had metal contents of 0.19 to 1.58 mass %, exhibited significantly lower expansion rates during charge-discharge of the lithium-ion battery compared to the active material of Comparative Example 1 which had a metal content of 0.01 mass %. Specifically, the expansion rates of the active materials of Examples 1 to 4 were 27.5%, 25.0%, 18.75% and 30.0%, respectively. The metals significantly infiltrating in Examples 1 to 4 were thought to be from the stainless steel (SUS304) cutter mill used in the clathrate Si production step. In particular, the use of a cutter mill for NaSi alloy production was thought to be the reason for infiltration of metal to the extent seen in Examples 1 to 4.

### Examples 5 to 14

A model of clathrate-type Si particles having a type II clathrate structure was constructed using VASP ver.5.4.1, creating a structure wherein randomly selected atoms from among the Si atoms in the model were replaced with other elements.

The same software was then used for structural optimization by implementing the pseudopotential PBEsol, and the most stable structure was used for calculation of the expansion/contraction rate.

The types of elements replacing Si atoms and the expansion/contraction rates for Examples 5 to 14 were as shown in Table 2.

TABLE 2

| | Different | Particle expansion rate |
|---|---|---|
| | element type | (relative value) |
| Example 5 | Zr | 28.10 |
| Example 6 | Ag | 27.90 |
| Example 7 | B | 28.60 |
| Example 8 | C | 29.70 |
| Example 9 | Co | 28.40 |
| Example 10 | Cr | 27.60 |
| Example 11 | Nb | 28.10 |
| Example 12 | Pd | 27.60 |
| Example 13 | Ti | 26.00 |
| Example 14 | V | 28.10 |

As shown in Table 2, reduction in the expansion/contraction rate is predicted for clathrate-type Si particles with a portion of the Si atoms replaced by Zr, Ag, B, C, Co, Cr, Nb, Pd, Ti or V.

### REFERENCE SIGNS LIST

1 Lithium-ion battery
11 Negative electrode collector layer
12 Negative electrode active material layer
13 Solid electrolyte layer
14 Positive electrode active material layer
15 Positive electrode collector layer

1. A negative electrode active material consisting of clathrate-type Si particles comprising one or more metals selected from the group consisting of Mo, Fe, Zn, Mg, Pd, Zr, Ag, Co, Cr, Nb and V.

2. The negative electrode active material according to claim 1, wherein the content of the metal with respect to the entire clathrate-type Si particles is 0.01 to 1.60 mass %.

3. The negative electrode active material according to claim 1, wherein the metal is interstitially doped in the clathrate-type Si particles.

4. The negative electrode active material according to claim 1, wherein the clathrate-type Si particles at least partially have a clathrate type II structure.

5. The negative electrode active material according to claim 1, which is for a lithium-ion battery.

6. A negative electrode active material layer comprising a negative electrode active material according to claim 1.

7. A lithium-ion battery having a negative electrode collector layer, a negative electrode active material layer according to claim 6, a solid electrolyte layer, a positive electrode active material layer and a positive electrode collector layer, in that order.

8. A method for producing a negative electrode active material, wherein the method includes:
supplying a mixture of NaSi alloy powder, a Na trap agent, and one or more metals selected from the group consisting of Mo, Fe, Zn, Mg, Pd, Zr, Ag, Co, Cr, Nb and V, and
heating the mixture at a heating temperature of 250 to 500° C. for a heating time of 30 to 200 hours.

9. The production method according to claim 8, which further includes mechanically milling a Si source, a NaH source and the metal, and heating them to obtain a mixture of the NaSi alloy powder and the metal.
